(19) United States
(12) Patent Application Publication
(10) Pub. No.: US 2024/0343294 A1
(43) Pub. Date: Oct. 17, 2024

(54) CONNECTION ROD UNIT OF A VEHICLE STEERING DEVICE

(71) Applicant: ZF Automotive Germany GmbH, Alfdorf (DE)

(72) Inventors: Ian BLÄSER, Bochum (DE); Rainer ENGEL, Krefeld (DE)

(21) Appl. No.: 18/634,447

(22) Filed: Apr. 12, 2024

(30) Foreign Application Priority Data
Apr. 14, 2023 (DE) 102023203409.3

(51) Int. Cl. B62D 3/12

(52) U.S. Cl. CPC B62D 3/126

(57) ABSTRACT

The present disclosure relates to a connection rod unit of a vehicle steering device, having a connection rod and having an attachment which is secured directly to the connection rod and which has a tooth arrangement. The attachment is produced from a plastics material, for example from polyamide or polyoxymethylene.

### CROSS-REFERENCE TO RELATED APPLICATION

This application claims priority to a German Application No. 102023203409.3, filed Apr. 14, 2023, the disclosure of which is incorporated herein by reference in its entirety.

### TECHNICAL FIELD

The disclosure relates to a connection rod of a vehicle steering device.

### BACKGROUND

Connection rod units for vehicle steering devices are known from the prior art. There are, for example, connection rod units of so-called Steer-by-Wire (SBW) steering devices, as known from DE 20 2022 100 964 U1. In these steering devices, there is no longer any continuous mechanical connection between the steering wheel and wheels of a vehicle. Instead, for the conversion of the steering wheel movement by a user into a movement of the steered wheels, there is used an electric motor which is connected, for example, by a belt to a spindle/nut module in order to displace the connection rod (in this instance, the spindle) along the axial extent thereof. In order to determine the position of the connection rod, there is provided a sensor unit which via a pinion is in engagement with a portion of the connection rod which has a tooth arrangement.

A comparable unit is known from EP 3 530 550 B1 in which a rotary sensor arrangement is used. This rotary sensor arrangement has a toothed rack which is supported by a retention member which is secured to the connection rod by two screws.

The disadvantage of such units is that the production of the tooth arrangement on the connection rod is labor-intensive and cost-intensive. Furthermore, a high level of wear may occur on both components.

### SUMMARY

Based on the forgoing, what is needed is to provide a connection rod unit of the type mentioned above which overcomes the above problems.

According to the disclosure, a connection rod is disclosed having an attachment which is secured directly to the connection rod and which has a tooth arrangement, wherein the attachment is produced from a plastics material, for example, from polyamide or polyoxymethylene.

With such a connection rod unit, the attachment may be produced separately from the connection rod, whereby the production of the connection rod is simplified since the production of the tooth arrangement on the connection rod, which is produced from a metal material, is dispensed with. Instead, the tooth arrangement may be formed during the production of the attachment, for example, during an injection-molding operation. Further, different plastics materials can be used, the selection of which can be selected in accordance with the material of a gear which meshes in the tooth arrangement of the attachment in order, for example, to increase the service-life of both components.

In one exemplary arrangement of the connection rod unit, the connection rod has a receiving portion for the attachment in which the attachment is received. The receiving portion of the connection rod may in this instance be configured in such a manner that a base region of the receiving portion is recessed with respect to a covering face of the connection rod, whereby the receiving portion has two opposing side regions. Alternatively, the receiving potion may extend over the entire length of the connection rod.

The receiving portion may facilitate the assembly of the connection rod unit by fixing the position of the attachment. Furthermore, as a result of the configuration of the retention portion, together with a corresponding configuration of the attachment, with a recessed base region, it may be possible after a securing of the attachment for the outer dimensions of the connection rod unit not to be changed. This is advantageous when the connection rod unit is used together with an external housing.

Further, the connection rod in the receiving portion may have a retention geometry for locking the attachment. For example, the retention geometry may be formed from a groove or an undercut, in which portions, for example opposing side regions of the attachment, engage in the assembled state. It is advantageous in this context for the attachment to have a degree of flexibility which enables an installation of the attachment in the receiving portion, for example, by the attachment being able to be sufficiently compressed in the region of the longitudinal extent thereof.

In another exemplary arrangement of the connection rod unit, the retention geometry may have at least one opening which is provided in the base region of the receiving portion and into which an associated connection element which protrudes from the attachment protrudes. The opening may in this instance have different cross sections which correspond to the geometry of the connection element. For example, the opening may be in the form of a hole and the connection element accordingly in the form of a cylinder or generally a pin. The opening may be arranged in a base region of the receiving portion suitable for receiving a connection element, wherein a central arrangement in the longitudinal and/or width extent of the base region is preferred. In a further advantageous manner, a plurality of openings may also be arranged in the base region. For example, the openings may, for example, be spaced apart from each other in the longitudinal extent of the base region, wherein the connection elements of the attachment are formed correspondingly on the attachment. In this manner, the positioning of the attachment in the receiving portion can be facilitated and the configuration with a plurality of opening/connection element combinations prevents a rotation of the attachment in the receiving portion. The opening/connection element combination may in this instance be provided for a positive-locking and/or non-positive-locking connection.

The connection elements may also lock in the openings.

In one exemplary arrangement, the receiving portion has locking profiles at mutually opposing side regions. A side region in the context of the application is intended to be understood to be regions which delimit the base region of the receiving portion, for example in the longitudinal extent thereof. The configuration of these side regions enables the attachment to be securely received in the receiving portion and consequently directly connected to the connection rod. The geometry of the locking profiles may be adapted to the regions of the attachment which are arranged in the locking profiles in the assembled state. It is also conceivable for the corresponding regions of the attachment to have a configuration which corresponds to the geometry of the locking profiles. Grooves or undercuts may be suitable as a locking profile. The locking profiles may extend over the entire width of the side regions or only partially. For example, an extent over at least one edge which delimits the side region in terms of the width thereof enables the attachment to be laterally inserted, so that it may also be configured in a rigid manner. Further, locking profiles may block a movement of the attachment in a perpendicular direction relative to the base region of the receiving portion when they partially protrude relative to the remainder of the side regions, for example, in the form of a locking projection, wherein they may be configured in a rounded manner in order to facilitate assembly of the attachment.

In one exemplary arrangement, the attachment has at opposing sides locking elements, for example resilient continuations, wherein the locking elements with an attachment having a different length and width extent are in one exemplary arrangement, arranged on opposing side regions in the longitudinal direction. When resilient continuations are used, the attachment may be configured to be rigid in the remainder of the attachment without making the assembly more difficult and in order to further produce a positive-locking and/or non-positive-locking connection between the attachment and receiving portion.

In another exemplary arrangement of the connection rod unit, the locking elements are continuations which are integrally formed on the remainder of the attachment and which engage in the locking profiles. The locking elements may in this instance be produced directly during the production process of the attachment, whereby a separate production is not required. As a result of this integral configuration, it is further possible for the total number of components to be able to be kept to a minimum in order to thus simplify the assembly.

In order to further improve the mechanical properties of the connection between the attachment and receiving portion, the attachment may be connected to the receiving portion in a materially engaging manner. It is thus, for example, conceivable for the locking elements together with the locking profiles to hold the attachment in position in the receiving portion during a drying time of an adhesive. After the drying of the adhesive, there is a play-free connection between the attachment and the receiving portion, which can contribute to improving a sensor precision.

In another advantageous exemplary arrangement of the connection rod unit, the attachment is configured in several pieces. For example, with a multi-piece configuration of the attachment, two identically configured attachment end portions, which each have a toothed portion and a locking element which is described above and which also has a toothed portion, can be connected, wherein the attachment end portions and the attachment central portion are configured to be connected to each other. As a result of the multi-piece configuration, for example, the attachment may in terms of its longitudinal extent, be adapted to different length requirements by a number of attachment end portions or attachment central portions which is intended to be defined being combined.

In one exemplary arrangement, a gear of a sensor is provided to establish the connection rod movement, which gear meshes in the tooth arrangement. The connection rod movement can thereby be translated into a movement of the gear which acts as a detection variable of the sensor.

In one exemplary arrangement, a tooth head face or tooth head line which is arranged on a tooth head of the tooth arrangement between a first tooth flank and a second tooth flank of the same tooth is orientated substantially parallel with a lower side of the attachment. A tooth head line is in this context intended to be understood to be a connection line which connects the locations furthest away from a tooth base of the respective teeth. With such an orientation, the connection rod unit may be used in already existing systems which are generally positioned on a housing in which the connection rod unit can be movably arranged and have a sensor system for determining the movement and/or position of the connection rod unit in the form of a gear, the rotation axis of which is orientated perpendicularly to the movement direction of the connection rod and parallel with the base region of the receiving portion.

Alternatively, a tooth head face or a tooth head line which is arranged on a tooth head of the tooth arrangement between a first tooth flank and a second tooth flank may be orientated substantially perpendicularly to a lower side of the attachment. Such an orientation may also be referred to as a perpendicular tooth arrangement and enables the rotation axis of the gear/shaft combination to be arranged perpendicularly to the base region of the receiving portion, whereby a more compact sensor arrangement can be enabled. As a result of this arrangement, the tooth arrangement covers the base region of the attachment only partially so that, for example, elements of the sensor can be arranged on or at the attachment.

In a further advantageous manner, the perpendicular tooth arrangement enables the attachment to also have a second tooth arrangement which is orientated parallel with the first tooth arrangement and consequently also perpendicularly, wherein an individual gear of sensors meshes with each of the two tooth arrangements in order to establish the connection rod movement. A parallel tooth arrangement is in this instance intended to be understood to mean that the tooth head face or the tooth head line of the first tooth arrangement is orientated parallel with a second tooth head face or second tooth head line which is arranged on a tooth head of the second tooth arrangement between a first tooth flank and a second tooth flank, wherein the teeth of the first tooth arrangement and the teeth of the second tooth arrangement may extend in the same direction or in opposing directions. As a result of the use of a second tooth arrangement, it may be possible for, in addition to the sensor, a second sensor to be used in order, for example, to enable a redundant establishment of the connection rod movement. Furthermore, the diversity of the sensor signals can also be increased when an arrangement of the first and second tooth arrangements or the individual gears of the sensors is selected in which the gears rotate in opposing directions so that, for example, during a connection rod movement, the first sensor outputs a rising signal and the second sensor outputs a falling signal.

In another exemplary arrangement, the attachment has a bearing portion for receiving a sensor element. A bearing portion may in this instance be formed by an opening, in which a shaft which carries the gear of the sensor or a bearing which receives the shaft, in for example a ball bearing, can be arranged. However, it is also possible for the bearing portion to be in the form of an axle, the center axis of which is, for example, also orientated perpendicularly to the lower side of the attachment. The gear of the sensor can then be supported in a rotationally movable manner on this axle. The spacing of the bearing portion with respect to the tooth arrangement is in this instance sized in such a manner that the gear of the sensor can mesh with the tooth arrangement in the assembled state.

### BRIEF DESCRIPTION OF THE DRAWINGS

Exemplary arrangements of the disclosure are explained in greater detail below with reference to the appended drawings. In the drawings:

FIG. 1 shows a vehicle steering device having a connection rod unit according to the disclosure,

FIG. 2 shows a first exemplary arrangement of a connection rod unit according to the disclosure of a vehicle steering device having a connection rod and an attachment in the assembled state as a perspective view,

FIG. 3 shows the connection rod having a retention geometry and an attachment as an exploded view,

FIG. 4 shows a second exemplary arrangement of a connection rod unit according to the disclosure having a connection rod and an attachment in the assembled state as a side view,

FIG. 5 shows a cut-out of the connection rod and the attachment according to FIG. 4 as a side view,

FIG. 6 shows another exemplary arrangement of the connection rod unit according to the disclosure having a connection rod and an attachment as a perspective view,

FIG. 7 shows the exemplary arrangement of the connection rod unit of FIG. 6 with two sensors, and

FIG. 8 shows another exemplary arrangement of the connection rod unit according to the disclosure having an attachment with two bearing portions and having gears which mesh in a first and second tooth arrangement of the attachment.

### DETAILED DESCRIPTION

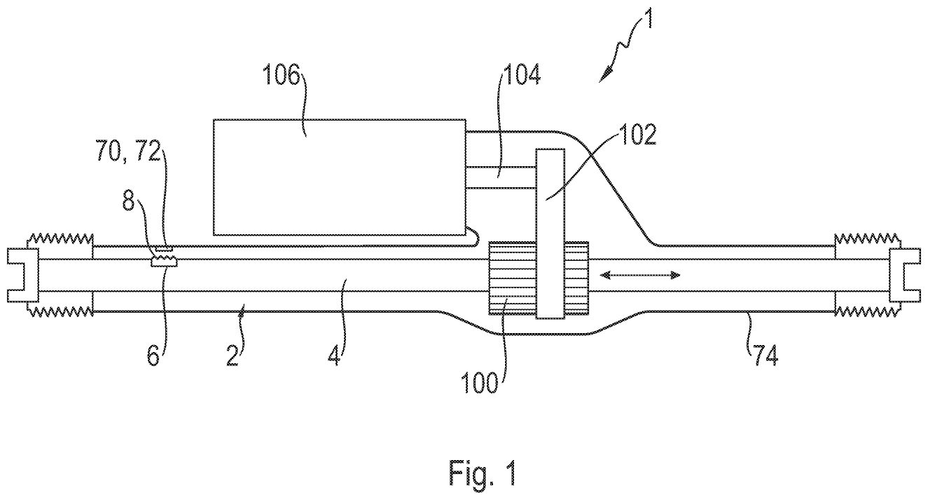

FIG. 1 shows a vehicle steering device 1 of a vehicle which in order to steer opposing wheels has a connection rod unit 2 which is coupled to the wheels in a mechanically secure manner and which has a connection rod 4 and an attachment 6 which will be explained in greater detail below and which is connected to the connection rod 4 in a rigid manner, is produced from plastics material (for example, from polyamide or polyoxymethylene) and has a tooth arrangement 8 which drives a gear of a sensor, as will be explained in greater detail below.

The connection rod 4 is in the present exemplary arrangement, for example, a spindle, wherein the spindle portion does not have to extend over the entire length of the connection rod, but instead over only a specific portion. In this portion, the spindle can be displaced in a spindle nut 100, which is supported in an axially secure but rotatable manner. The spindle nut 100 is, for example, rotated by a belt 102 which is positioned on a pinion 104 of an electric motor 106.

The vehicle steering device 1 is a steer-by-wire steering device, that is to say, there is no mechanical connection between the steering wheel and the connection rod 4. Instead, the movement and deflection of the steering wheel is established using sensors and converted in a control system into signals for the motor 106 so that the motor 106 via the belt 102 can redirect the nut 100 and consequently the connection rod 4 in opposing lateral directions, according to the desired steering action.

The position of the connection rod 4 has to be permanently established so that the control system knows the actual state of the connection rod 4.

To this end, the attachment 6 which will be explained in greater detail below is provided.

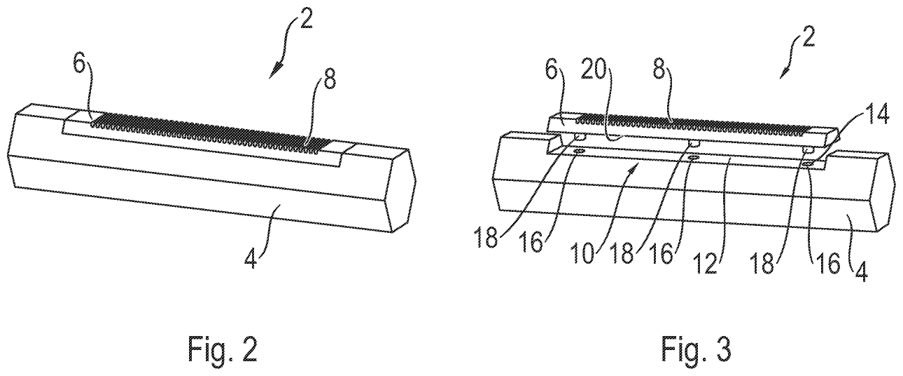

It is possible to see in FIG. 2 the connection rod 4 which in order to receive the attachment 6 has a recess in the form of a receiving portion 10. The receiving portion 10 is, as can be seen in FIG. 2, adapted to the outer geometry, in this instance the longitudinal and thickness dimensions and the transverse dimensions of the attachment 6 so that the attachment 6 fills the receiving portion 10 and does not protrude with respect to the envelope of the connection rod 4, wherein this is only optionally the case.

The receiving portion 10 is delimited by a base region 12 (see FIG. 3) which has a retention geometry 14, in this instance in the form of three openings which are spaced apart from each other in a longitudinal extent of the connection rod 4 and into which associated connection elements 18 protrude in the assembled state of the attachment 6 in order to secure the attachment 6 to the connection rod 4.

The connection elements 18 protrude from the lower side 20 of the plate-like attachment 6 but are an integral component thereof.

The connection elements 28 may have lateral locking projections with which they engage in undercuts in the openings 16. Otherwise, they may also be secured in the openings 16 by means of a press-fit connection. Furthermore, adhesive can also be used for securing.

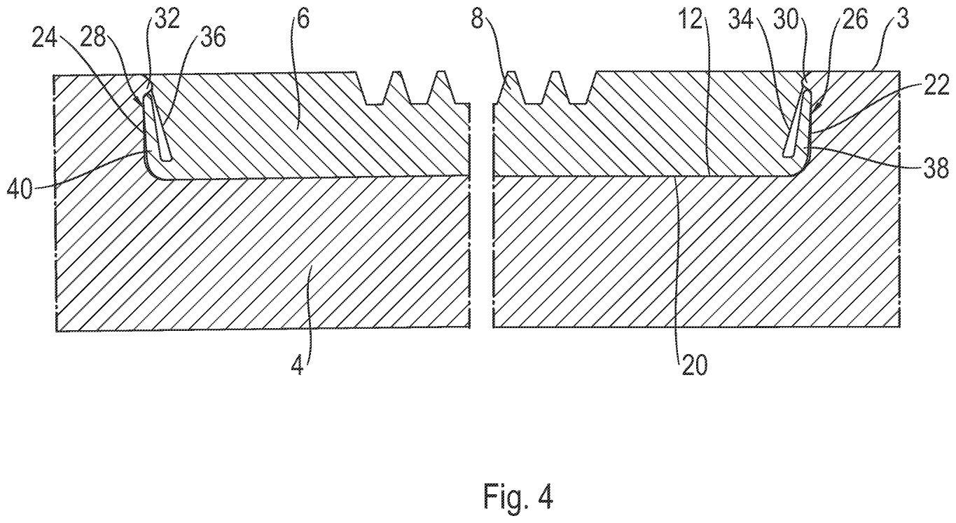

FIG. 4 shows a variant of the connection rod unit 2 having the connection rod 4 in the receiving portion 10 of which the attachment 6 is received. In this state, the base region 12 of the receiving portion 10 is in contact with the lower side 20 of the attachment 6.

For secure connection of the attachment 6 inside the receiving portion 10, the receiving portion 10 has locking profiles 26 and 28 which are formed on the opposing side regions 22 and 24 thereof and which in the embodiment shown are in the form of undercuts which are delimited at an upper end of the locking profiles 26, 28, that is to say, at the end facing away from the base region 12, by locking projections 30, 32. Locking elements 38, 40 which are formed integrally on opposing sides 34, 36 of the attachment 6 and are in the form of resilient continuations engage in the locking profiles 26, 28.

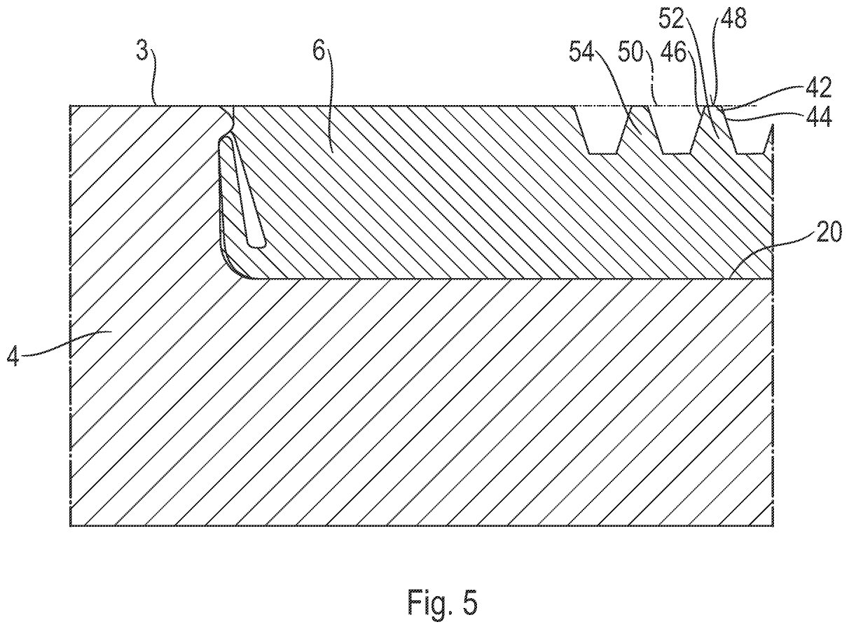

In FIG. 5, a cut-out of the connection rod 4 of the attachment 6 and the tooth arrangement 8 is shown in detail, wherein a tooth head face 48 which is arranged on a tooth head 42 between a first tooth flank 44 and a second tooth flank 46 of the same tooth is orientated parallel with the lower side 20 of the attachment 6.

In this instance, a tooth head line 50 is located partially in the tooth head faces 48 of the tooth arrangement 8. The tooth head line 50 is in this instance the connection line which connects the locations furthest away from a tooth base 52, 54 of the respective teeth (only two teeth are shown in the Figure).

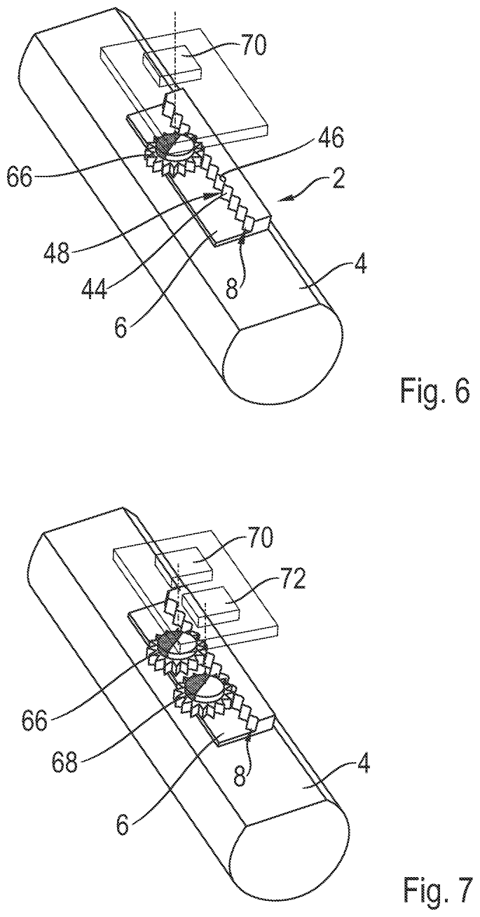

FIGS. 6 to 8 show an alternative exemplary arrangement of the tooth arrangement 8 of the attachment in which the individual teeth extend in the transverse direction thereof perpendicularly relative to the lower side 20 of the attachment 6, that is to say, the teeth do not protrude freely in the direction toward the tooth head, but instead the teeth extend in the transverse direction away from the upper side of the remainder of the attachment 6. In other words, the tooth head face 48 which is arranged between a first tooth flank 44 and a second tooth flank 46 extends substantially perpendicularly to the lower side 20 of the attachment 6.

FIG. 6 shows a tooth arrangement 8 and a gear 66 which meshes with the tooth arrangement 8 so that the gear 66 which is supported in a fixed manner rotates when the tooth arrangement 8 runs past the gear 66 when the connection rod 4 is displaced.

The gear 66 is retained in a fixed manner, for example, on a sensor 70 which is secured on or in a housing 74 (see FIG. 1) which surrounds the connection rod unit 2.

In the exemplary arrangement according to FIG. 7, two gears 66, 68 which mesh with the same tooth arrangement 8 are provided. There is associated with each gear 66, 68 a sensor 70, 72 which can detect the rotation of the gear 66, 68 thereof and which consequently can detect the position of the connection rod 4.

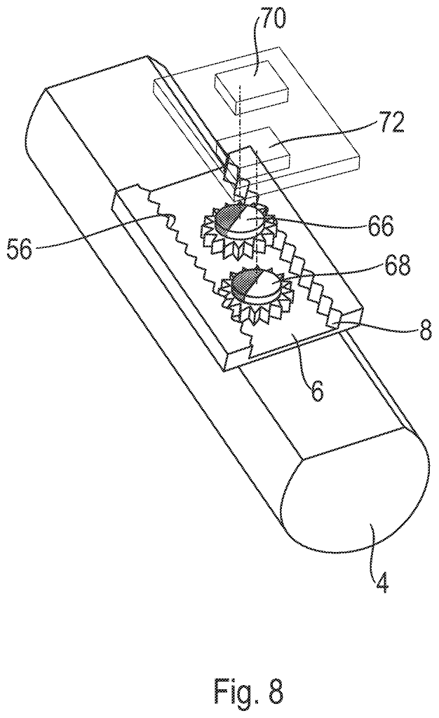

In the variant according to FIG. 8, two tooth arrangements 8, 56 are formed on the attachment 6, wherein the gear 66 meshes with the tooth arrangement 8 and the gear 68 meshes with the tooth arrangement 56. In this instance, the gears 66, 68 rotate in opposing directions in order to increase the diversity of the sensor signals, for example, in the case of a rising or falling signal.

Two gears 66, 68 generally increase the reliability and lead to a redundancy.

Various sensors which operate magnetically, inductively, resistively, optically, etcetera, can be considered to be sensors. For example, they may be multiturn sensors which operate in accordance with the Vernier principle or rotary angle sensors having an index sensor, to mention just a few examples.

1. A connection rod unit of a vehicle steering device, comprising:
a connection rod and
an attachment which is secured directly to the connection rod and which has a tooth arrangement,
wherein the attachment is produced from a plastics material.

2. The connection rod unit as claimed in claim 1, wherein the connection rod has a receiving portion for the attachment in which the attachment is received.

3. The connection rod unit as claimed in claim 2, wherein the connection rod has in the receiving portion a retention geometry for locking the attachment.

4. The connection rod unit as claimed in claim 3, wherein the retention geometry has at least one opening which is provided in a base region of the receiving portion and into which an associated connection element which protrudes from the attachment protrudes.

5. The connection rod unit as claimed in claim 3, wherein the receiving portion has locking profiles at mutually opposing side regions.

6. The connection rod unit as claimed in claim 2, wherein the attachment has at opposing sides locking elements.

7. The connection rod unit as claimed in claim 5, wherein the locking elements are continuations which are integrally formed on the remainder of the attachment and which engage in the locking profiles.

8. The connection rod unit as claimed in claim 1, wherein a tooth head face or tooth head line which is arranged on a tooth head of the tooth arrangement between a first tooth flank and a second tooth flank is orientated substantially parallel with a lower side of the attachment.

9. The connection rod unit as claimed in claim 1, wherein a tooth head face which is arranged on a tooth head of the tooth arrangement between a first tooth flank and a second tooth flank is orientated substantially perpendicularly to a lower side of the attachment.

10. The connection rod unit as claimed in claim 1, wherein a gear of a sensor which meshes with the tooth arrangement is provided to establish the connection rod movement.

11. The connection rod unit as claimed in claim 9, wherein the attachment has a second tooth arrangement which is orientated parallel with the first tooth arrangement, wherein an individual gear meshes with each of the two tooth arrangements in order to establish the connection rod movement.

12. The connection rod unit as claimed in claim 1, wherein the plastics material is one of polyamide or polyoxymethylene.

13. The connection rod unit as claimed in claim 4, wherein the receiving portion has locking profiles at mutually opposing side regions.

14. The connection rod unit as claimed in claim 5, wherein the attachment has at opposing sides locking elements.

15. The connection rod unit as claimed in claim 5, wherein the locking elements are continuations which are integrally formed on the remainder of the attachment and which engage in the locking profiles.

16. The connection rod unit as claimed in claim 15, wherein a tooth head face or tooth head line which is arranged on a tooth head of the tooth arrangement between a first tooth flank and a second tooth flank is orientated substantially parallel with a lower side of the attachment.

17. The connection rod unit as claimed in claim 16, wherein a tooth head face which is arranged on a tooth head of the tooth arrangement between a first tooth flank and a second tooth flank is orientated substantially perpendicularly to a lower side of the attachment.

18. The connection rod unit as claimed in claim 16, wherein a gear of a sensor which meshes with the tooth arrangement is provided to establish the connection rod movement.
